(19) United States
(12) Patent Application Publication
(10) Pub. No.: US 2024/0143784 A1
(43) Pub. Date: May 2, 2024

(54) METHOD, APPARATUS, SYSTEM, AND COMPUTER PROGRAM FOR MANAGING SOFTWARE COMPONENT

(71) Applicant: SAMSUNG SDS Co., Ltd., Seoul (KR)

(72) Inventors: Changhoon LEE, Seoul (KR); Jihoon CHO, Seoul (KR); Hunhee YU, Seoul (KR); Young Hwa LEE, Seoul (KR); Janghyuk AHN, Seoul (KR)

(73) Assignee: SAMSUNG SDS Co., Ltd., Seoul (KR)

(21) Appl. No.: 18/382,623

(22) Filed: Oct. 23, 2023

(30) Foreign Application Priority Data
Oct. 27, 2022 (KR) 10-2022-0140550

(51) Int. Cl. G06F 21/57; G06F 8/61

(52) U.S. Cl. CPC G06F 21/577; G06F 8/61; G06F 2221/033

(57) ABSTRACT

The present disclosure relates to a method, an apparatus, a system, and a computer program for managing a software component and, more specifically, to a method, an apparatus, a system, and a computer program for managing several software components such as an operating system and a hypervisor constituting a cloud environment. The present disclosure provides a method for managing multiple types of software components, the method being performed by one or more processors in a proxy server, and including: receiving a request for installation of one or more software components among the multiple types of software components, and transferring the received request to each corresponding software provision unit; receiving, from the software provision unit, each of one or more pieces of software installation data for installation of the one or more software components; and determining whether to provide the one or more pieces of software installation data, so as to perform installation of the one or more software components, through verification of the one or more pieces of software installation data.

### CROSS-REFERENCE TO RELATED APPLICATION(S)

This application is based on and claims priority under 35 U.S.C. 119 to Korean Patent Application No. 10-2022-0140550, filed on Oct. 27, 2022, in the Korean Intellectual Property Office, the disclosure of which is herein incorporated by reference in its entirety.

### BACKGROUND OF THE INVENTION

### 1. Field of the Invention

The present disclosure relates to a method, an apparatus, a system, and a computer program for managing a software component and, more specifically, to a method, an apparatus, a system, and a computer program for managing several software components such as an operating system and a hypervisor constituting a cloud environment.

### 2. Description of the Prior Art

Recently, a cloud-related technology providing IT resources on the basis of Internet has widely spread, and various cloud services have also rapidly grown on the basis of the cloud-based technology.

More specifically, a cloud service is a service of providing, through Internet, an application, system software, etc. operating on the basis of multiple servers installed in a data center, etc.

In this case, to implement such a cloud environment, various software components such as an operating system, a hypervisor, a virtual machine image, a container orchestrator, a container image, and an application may be provided.

However, generally, various software components constituting a cloud environment may be individually managed to be installed and updated according to a scheme designated in each software piece, and moreover, even in a case where each software component is managed in a similar scheme, it is common that different tools need to be used and separately managed in actual respective software pieces, as tools for performing management (for example, apt of Ubuntu Linux and yum of Red hat Linux).

Moreover, conventionally, software verification and management have been performed in a scheme in which at an installation and update time point, a manager inspects a hash value for a software package before installing the package, or before a package to which a code signature is applied is installed, an installation target system (for example, OS) or the package itself performs verification. In addition, a scheme, in which in an operation time point, security of installed software is verified by utilizing a separate application, etc. (for example, vaccine application), or a connection to a target system is periodically performed so that vulnerability is verified through scanning or the like of the installed software, has been used.

Accordingly, in the conventional art above, not only there was difficulty in management due to different distribution and management schemes for each software component and lack consistency, but also a problem of omitting management for some software could occur, and moreover, a problem of failure in securing visuality due to difficulty in identifying software installed or installable in a current cloud could be followed.

Moreover, such software component management is not limited to a cloud environment only, and a similar problem may be caused in an on-premise environment, etc.

Accordingly, there is a constant demand for a method by which a consistent environment for management of several software components can be provided for a cloud environment, etc., and an installation and update status of the software components can be easily identified.

### SUMMARY OF THE INVENTION

The present disclosure is designed to solve the above-described problems in the conventional art, and is to provide a method, an apparatus, a system, and a computer program for managing a software component in which a concentrated and consistent environment for management of several software components in a cloud environment, etc. can be provided.

In addition, the present disclosure is to provide a method, an apparatus, a system, and a computer program for managing a software component, in which visibility enabling easy and clear identification of information on installation, upgrade, etc. of software components constituting a cloud environment can be provided.

Technical problems to be solved in the present disclosure are not limited to the technical problems mentioned above, and other unmentioned technical problems could be clearly understood from the contents disclosed herein by those skilled in the art to which the present disclosure belongs.

In order to solve the problems, a method for managing a software component according to an aspect of the present invention includes, in a method for managing multiple types of software components, the method being performed by one or more processors in a proxy server: receiving a request for installation of one or more software components among the multiple types of software components, and transferring the same to each corresponding software provision unit; receiving, from the software provision unit, each of one or more pieces of software installation data for installation of the one or more software components; and determining whether to provide the one or more pieces of software installation data, so as to perform installation of the one or more software components, through verification of the one or more pieces of software installation data.

Here, the determining may include applying, by the proxy server, a predetermined policy, and determining whether to provide the one or more pieces of software installation data, through verification of the one or more pieces of software installation data.

In addition, the determining may include storing, by the proxy server, a result of the verification of the one or more pieces of software installation data in a database.

In addition, the determining may include storing, by the proxy server, meta information relating to details about provision of the one or more pieces of software installation data in a database.

In this case, in the determining, the meta information may include one or more of identification information of the software component, version information, type information, information on a transmission time point, and information on an item of verification performed for the software installation data.

In addition, the method for managing a software component may further include transmitting a part or all of the meta information stored in the database to a terminal so as to provide the same to a manager.

In addition, a method for managing a software component according to another aspect of the present disclosure includes, in a method for managing multiple types of software components, the method being performed by one or more processors in a software monitor: receiving meta information relating to installation of one or more software components among the multiple types of software components; and verifying the one or more software components on the basis of the meta information, wherein the meta information corresponds to information on details about provision, by a proxy server, of each piece of software installation data for installation of the multiple types of software components.

Here, the verifying may include: verifying the one or more software components in association with a vulnerability database in which information on vulnerability of the multiple types of software components is managed; and performing integrity verification for the one or more software components on the basis of the meta information.

In addition, the verifying may include verifying, by the software monitor, the one or more software components in connection with an agent of each of the one or more software components.

In addition, the verifying may include storing, as the meta information, a result of the verification of the one or more software components.

In addition, a computer-readable storage medium according to another aspect of the present disclosure is a computer-readable storage medium for storing instructions configured to, when executed by a processor, cause an apparatus including the processor to implement operations for managing multiple types of software components, and the operations may include: receiving a request for installation of one or more software components among the multiple types of software components, and transferring the received request to each corresponding software provision unit; receiving, from the software provision unit, each of one or more pieces of software installation data for installation of the one or more software components; and determining whether to provide the one or more pieces of software installation data, so as to perform installation of the one or more software components, through verification of the one or more pieces of software installation data.

In addition, a computer-readable storage medium according to another aspect of the present disclosure is a computer-readable storage medium storing instructions configured to, when executed by a processor, cause an apparatus including the processor to implement operations for managing multiple types of software components, and the operations may include: receiving meta information relating to installation of one or more software components among the multiple types of software components; and verifying the one or more software components on the basis of the meta information, wherein the meta information corresponds to information on details about provision, by a proxy server, of each piece of software installation data for installation of the multiple types of software components.

In addition, a proxy server according to another aspect of the present disclosure is a proxy server configured to manage multiple types of software components, wherein the processor is configured to: receive a request for installation of one or more software components among the multiple types of software components, and transfer the received request to each corresponding software provision unit; receive, from the software provision unit, each of one or more pieces of software installation data for installation of the one or more software components; and determine whether to provide the one or more pieces of software installation data, so as to perform installation of the one or more software components, through verification of the one or more pieces of software installation data.

Here, the determining whether to provide the data may include applying a predetermined policy to determine whether to provide the one or more pieces of software installation data, through verification of the one or more pieces of software installation data.

In addition, the determining whether to provide the data may include storing, in a database, a result of the verification of the one or more pieces of software installation data.

In addition, the determining whether to provide the data may include storing, in a database, meta information relating to details about provision of the one or more pieces of software installation data.

In this case, the meta information may include one or more of identification information of the software component, version information, type information, information on a transmission time point, and information on an item of verification performed for the software installation data.

In addition, the proxy server may further include an information provision unit configured to transmit a part or all of the meta information stored in the database to a terminal so as to provide the same to a manager.

In addition, a software monitor according to another aspect of the present disclosure is a software monitor configured to manage multiple types of software components, wherein the processor is configured to: receive meta information relating to installation of one or more software components among the multiple types of software components; and verify the one or more software components on the basis of the meta information, and the meta information corresponds to information on details about provision, by a proxy server, of each piece of software installation data for installation of the multiple types of software components.

Here, the verifying may include: verifying the one or more software components in association with a vulnerability database in which information on vulnerability of the multiple types of software components is managed; and performing integrity verification for the one or more software components on the basis of the meta information.

Accordingly, in a method, an apparatus, a system, and a computer system for managing a software component according to an embodiment of the present disclosure, a concentrated and consistent environment for management of several software components constituting a cloud environment, etc. can be provided.

In addition, in a method, an apparatus, a system, and a computer system for managing a software component according to an embodiment of the present disclosure, visibility enabling easy and clear identification of information on installation, upgrade, etc. of software components constituting a cloud environment can be provided.

More specifically, conventionally, an update file, or the like is differently distributed to each distribution server for each software component, but in a method, an apparatus, a system, and a computer system for managing a software component according to an embodiment of the present disclosure, integrated management and installation can be performed for several software components through a network proxy, and moreover, information on upgrade, etc. of several software components can be integrally identified through the network proxy, and thus can be efficiently managed.

Effects obtainable from the present disclosure are not limited to the above-mentioned effects, and other unmentioned effects could be clearly understood from the contents disclosure herein by those skilled in the art to which the present disclosure belongs.

### BRIEF DESCRIPTION OF THE DRAWINGS

The above and other aspects, features, and advantages of the present disclosure will be more apparent from the following detailed description taken in conjunction with the accompanying drawings, in which:

FIG. 1 illustrates an operation environment of a software component installation system according to an embodiment of the present disclosure;

FIG. 2 is a flow chart illustrating a method for managing a software component according to an embodiment of the present disclosure;

FIG. 3 illustrates specific operations of a method for managing a software component according to an embodiment of the present disclosure;

FIG. 4 is a flow chart illustrating a method for managing a software component according to another embodiment of the present disclosure;

FIG. 5 is a flow chart specifically illustrating an operation of performing verification in a method for managing a software component according to another embodiment of the present disclosure;

FIG. 6 illustrates specific operations of a method for managing software components according to another embodiment of the present disclosure;

FIG. 7 is a block diagram illustrating a software management server according to another embodiment of the present disclosure; and

FIG. 8 illustrates a specific configuration of a software management server according to another embodiment of the present disclosure.

### DETAILED DESCRIPTION OF THE EXEMPLARY EMBODIMENTS

Hereinafter, embodiments disclosed in this specification will be described in detail with reference to the accompanying drawings. Objectives, particular advantageous, and novel features of the present disclosure will become clearer from following descriptions and exemplary embodiments taken together with the accompanying drawings.

Terms or words used in this specification and the claims correspond to concepts defined appropriately by inventors to best describe the disclosure, are to be interpreted as having meanings and concepts conforming to the technical idea of the present disclosure, are given only to describe embodiments, and are not to be interpreted as limiting the present disclosure.

In connection with assigning reference numerals to components, identical or similar components will be given identical reference numerals, and repeated descriptions thereof will be omitted herein. Suffixes “module” and “unit” regarding components used in the following description are assigned or used interchangeably such that the specification can be composed easily, do not have meanings or roles distinguished from each other per se, and may denote software or hardware components.

In connection with describing components of the present disclosure, a component expressed in a singular form is to be understood as including a plural form of the component unless otherwise specified. In addition, terms such as “first”, “second”, and the like are used to distinguish a component from another component, and the component is not limited by such terms. In addition, the description that a component is connected to another component includes the possibility that another component may be connected between the two components.

In addition, in connection with describing embodiments disclosed in this specification, detailed descriptions regarding relevant known arts may be omitted when it is determined that such descriptions may obscure the gist of embodiments disclosed in this specification. In addition, the accompanying drawings are only for facilitating understanding of embodiments disclosed in this specification, and do not limit the technical idea disclosed in this specification, which is to be understood as including all changes, equivalents, and replacements falling within the idea and technical scope of the present disclosure.

Hereinafter, embodiments of a method, an apparatus, a system, and a computer program for managing a software component according to the present disclosure will be described in detail with reference to accompanying drawings.

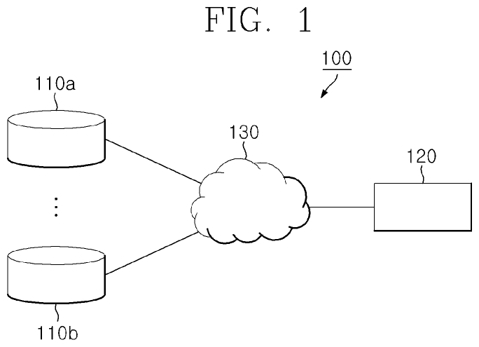

First, FIG. 1 illustrates a configuration and an operation of a software component installation system 100 according to an embodiment of the present disclosure. As shown in FIG. 1, the software component installation system 100 according to an embodiment of the present disclosure may include a cloud system 120 and one or more software provision units 110a, . . . , and 110b for providing software installation data such as an installation file or an update file for installation and updating of software components constituting a cloud environment, such as an operating system, a hypervisor, and a virtual machine image for the cloud system 120.

Here, the cloud system 120 may include several software components such as an operating system, a hypervisor, a virtual machine image, a container orchestrator, a container image, and an application, based on hardware such as one or more servers.

In this case, FIG. 1 illustrates a configuration of managing the software component while installing or updating the same for the cloud system (120), but the present disclosure is not mandatorily limited to the cloud environment, and in addition to the cloud environment, may be applied for the management of software in various environments such as an on-premise environment.

In addition, the software provision units 110a, . . . , and 110b may be software repositories for opensource software, commercial software, or the like, but the present disclosure is not mandatorily limited thereto, and in addition to the software provision units, may be implemented as various types of apparatuses capable of providing software installation data such as an installation file or an update file for installation, updating, or the like of the software component. More specifically, the software provision units 110a, . . . , and 110b may be implemented using one server or two or more servers, but the present disclosure is not mandatorily limited thereto, and in addition to the servers, may be configured using a personal computing processing apparatus such as a desktop computer, a lap top computer, a tablet, and a smartphone, or may be implemented in various forms such as an apparatus dedicated to provide a software installation file, etc.

In addition, in FIG. 1, as a communication network 130 for connection the software provision units 110a, . . . , and 110b and the cloud system 120, a wired network, a wireless network, and the like may be used, and specifically, various communication networks such as a local area network (LAN), a metropolitan area network (MAN), and a wide area network (WAN) may be included. In addition, the communication network 130 may include the well-known World Wide Web (WWW). Moreover, the communication network 130 may be implemented using a data bus, etc. configured to transmit or receive data, etc.

In addition, in the present disclosure, the software provision units 110a, . . . , and 110b and the cloud system 120 do not mandatorily need to transmit or receive data through the communication network 130 in the software component installation system 100, and may be implemented in various forms such as a case where the software provision units 110a, . . . , and 110b and the cloud system 120 are integrally configured.

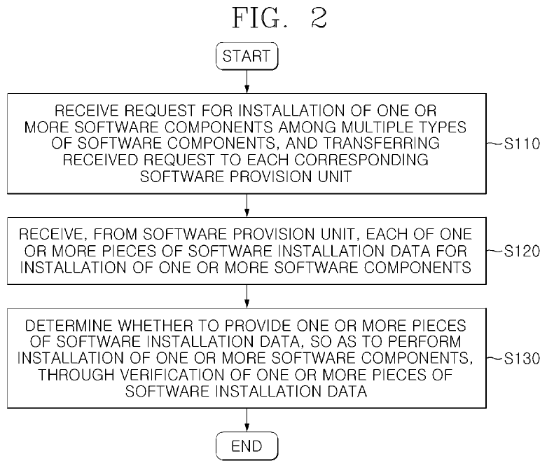

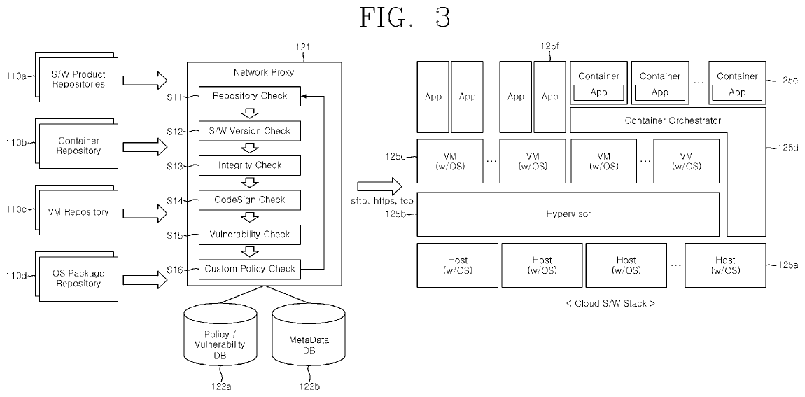

In addition, FIG. 2 is a flow chart illustrating a method for managing a software component according to an embodiment of the present disclosure, and FIG. 3 is a diagram specifically illustrating a method for managing a software component according to an embodiment of the present disclosure.

First, as shown in FIG. 2, a method for managing a software component according to an embodiment of the present disclosure may include, in a method which is performed by one or more processors in a proxy server 121 and manages multiple types of software components: receiving a request for installation of one or more software components among the multiple types of software components and transferring the same to each of corresponding software provision units 110a, . . . , and 110d (operation S110); receiving, from the software provision units 110a, . . . , and 110d, one or more pieces of software installation data for installation of the one or more software components (operation S120); and determining whether to provide the one or more pieces of software installation data, so as to perform installation of the one or more software components, through verification of the one or more pieces of software installation data (operation S130).

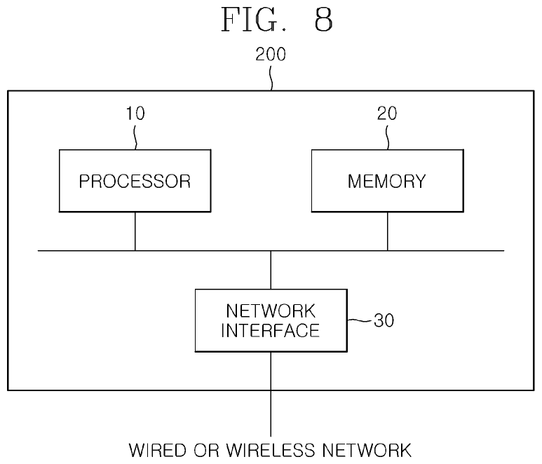

The method illustrated in FIG. 2 may be performed by, for example, the proxy server 121, and moreover, the proxy server 121 may be implemented to include a computing device in FIG. 8 and the following description in relation to FIG. 8. For example, the proxy server 121 may include a processor 10, and the processor 10 may manage the software component by executing an instruction configured to implement an operation of managing the multiple types of software components.

Here, the determining (operation S130) may include applying, by the proxy server 121, a predetermined policy, and determining whether to provide the one or more pieces of software installation data, through verification of the one or more pieces of software installation data.

In addition, the determining (operation S130) may include storing, by the proxy server 121, a result of the verification of the one or more pieces of software installation data in a database 122b.

In addition, the determining (operation S130) may include storing, by the proxy server 121, meta information relating to details about provision of the one or more pieces of software installation data in a database 122b.

In this case, in the determining (operation S130), the meta information may include one or more of identification information of the software component, version information, type information, information on a transmission time point, and information on an item of verification performed for the software installation data.

Moreover, the method for managing a software component according to an embodiment of the present disclosure may further include transmitting (not shown) a part or all of the meta information stored in the database 122b to a terminal so as to provide the same to a manager.

Accordingly, in a method, an apparatus, a system, and a computer system for managing a software component according to an embodiment of the present disclosure, a concentrated and consistent environment for management of several software components constituting a cloud environment, etc. can be provided, and moreover, visibility enabling easy and clear identification of information on installation, upgrade, etc. of software components constituting a cloud environment can be provided.

Hereinafter, the method for managing a software component according to an embodiment of the present disclosure is described in more detail with reference to FIGS. 2 and 3.

First, the transferring (operation S110) may include receiving a request for installation of one or more software components among the multiple types of software components, and transferring the same to each of corresponding software provision units 110a, . . . , and 110d.

In a more specific example, as shown in FIG. 3, when an operating system (for example, Linux) of a host 125a is installed in a software stack (SW stack) constituting a cloud environment, the proxy server 121 may receive a request for installation of the operating system and transfer the same to the software provision unit 110d corresponding to a software repository (SW repository) corresponding to the operating system.

In this case, the installation of software in the present disclosure may include not only initial installation of software but also installation for software update, software recovery, etc.

In addition, in the present disclosure, the proxy server 121 may be implemented as a separate server device, but the present disclosure is not limited thereto, and in addition to the server device, may be implemented in various forms such as a case where the proxy server is implemented as software, etc. operating on a server device.

In addition, in the present disclosure, the proxy server 121 does not need to directly transfer a request for installation of a first software component to the software provision units 110a, . . . , and 110d for providing the software component, and may be implemented in various schemes such as a case where the request is transferred to a server other than the software provision units 110a, . . . , and 110d, and the software component is provided through the other server.

In addition, the installation of the software component may be requested by an installation management program of the cloud system 120, or may be requested by an individual installation management program of each software component, but the present disclosure is not limited thereto.

Accordingly, in operation S110, the proxy server 121 receives the request for installation of one or more software components among the multiple type of software components, and transfers the same to each of the corresponding software provision units 110a, . . . , and 110d.

In addition, in operation S120, the proxy server 121 receives, from each of the software provision units 110a, . . . , and 110d, one or more pieces of software installation data for installation of the one or more software components.

In a more specific example, when there is a request for installation of the operating system in FIG. 3, the proxy server 121 may receive software installation data such as an installation file for installing the operating system from the software provision unit 110d corresponding to a software repository (SW repository) for the operating system.

In operation S130, the proxy server 121 determines whether to provide the one or more pieces of software installation data, so as to perform installation of the one or more software components, through verification of the one or more pieces of software data.

In a more specific example, in FIG. 3, when the proxy server 121 receives software installation data such as an installation file for installing the operating system from the software provision unit 110d corresponding to a software repository (SW repository) for an operating system, the proxy server 121 may perform verification of software installation data for the operating system, and determine whether to provide the software installation data for the operating system according to a result of the verification, so as to install the operating system in the cloud system 120.

More specifically, as shown in FIG. 3, the proxy server 121 may perform one or more of verification S11 for the software repositories 110a, . . . , and 110d having provided the software installation data, software version verification S12 for the received software installation data, integrity verification S13, certificate verification S14, vulnerability verification S15, and verification S16 according to a policy configured in each cloud system 120.

In addition, in operation S130, the proxy server 121 may store a result of the verification of the one or more pieces of software installation data in a database 122b.

Moreover, in operation S130, the proxy server 121 may store, in the database 122b, meta information relating to the details about provision of the one or more pieces of software installation data.

Accordingly, in the method for managing a software component according to an embodiment of the present disclosure, installation for multiple types of software components constating a cloud environment, etc. is performed through the proxy server 121, and in this case, the proxy server 121 is allowed to perform verification of the software installation data, thereby systematically verifying and installing various software components.

In addition, in the method for managing a software component according to an embodiment of the present disclosure, the proxy server 121 may store meta information relating to the details about transmission of the software installation data in the database 122b, and may also store a result of the verification of the software installation data in the database 122b.

Moreover, the meta information stored in the database 122b may include one or more of identification information of the software component, version information, type information, information on a transmission time point, and information on an item of verification performed for the software installation data.

The method for managing a software component according to an embodiment of the present disclosure may further include transmitting a part or all of the meta data stored in the database 122b to a terminal so as to provide the same to a manager.

Accordingly, in the method for managing a software component according to an embodiment of the present disclosure, various meta information for the multiple types of software components constituting a cloud environment, etc. can be collected and managed, and the meta information can be reflected to the management of the software component and can be provided to a manager.

In addition, with respect to the method for managing a software component according to an embodiment of the present disclosure, a more specific example of an operation in the perspective of installation or updating is described.

First, in the present disclosure, a policy for a software component constituting a cloud environment may be established, and may be connected with a network policy.

In this case, as the network policy, a policy including the following items may be configured.
Define checking criteria (for example, a software version, integrity, etc.) and checking order for each software type
Vulnerability checking criteria for each software type

In this case, in the present disclosure, different policies of an installation time point and an updating time point may be configured as in the following example, etc.
During updating, allow installation of later versions only, compared to a pre-installed version (that is, restrict installation of the same version or the previous version)

In addition, in the present disclosure, vulnerability information relating to a software component may be connected with a network policy (for example, in FIG. 3, vulnerability information and policy information may be connected, and stored and managed in the database 122a).

Accordingly, as shown in FIG. 3, in the present disclosure, the proxy server 121 may transmit software installation data, etc. for installation of a software component through a protocol such as sftp, https, and tcp, and in this case, the proxy server 121 may be compulsorily connected in installation of the software component, through a policy such as restriction on communication with an external network in a case of proxy disconnection.

More specifically, a series of following processes may be performed in the method for managing a software component according to an embodiment of the present disclosure.
(1) First, a configuration of the proxy server 121 may be performed for a package installation manager operating in a cloud environment.
(2) Thereafter, when installation of a specific software component is requested, the package installation manager transfers the request to a software provision 110 such as a software repository through the configured proxy server 121.
(3) Accordingly, the software provision unit 110 such as the software repository transmit software installation data of the requested software component through the proxy server 121.
(4) In this case, the software installation data may include an installation package such as an installation file for the requested software component.
(5) The proxy server 121 may perform checking by reflecting a pre-defined policy and vulnerability criterion for the installation package such as the installation file for the software component included in the software installation data.
(6) Accordingly, when the proxy server 121 transfers, to the package installation manager, the software installation data for which the checking is completed, the package installation manager performs installation for the software component by using the software installation data.

In addition, as shown in FIG. 3, the proxy server 121 may perform security checking (for example, a software repository for connection, a software version, integrity, a code signature, vulnerability, a user-defined policy, etc.) for the transmitted software installation data according to a configured policy.

In this case, the proxy server 121 may store a result (for example, success/failure) of the security checking in a database 122b.

Moreover, the proxy server 121 may perform processing to transmit the software installation data only when the result of the security checking is successfully performed, and then may store details of the processing in the database 122b.

In this case, meta information stored in the database 122b may include a software identifier and version, a software type (for example, a container, a virtual machine (VM), etc.), whether a distribution has succeeded, a date and time of record of meta information, a performed checking item, etc.

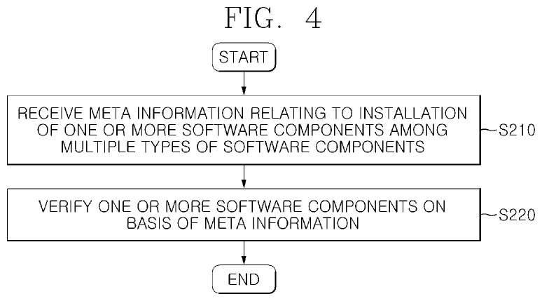

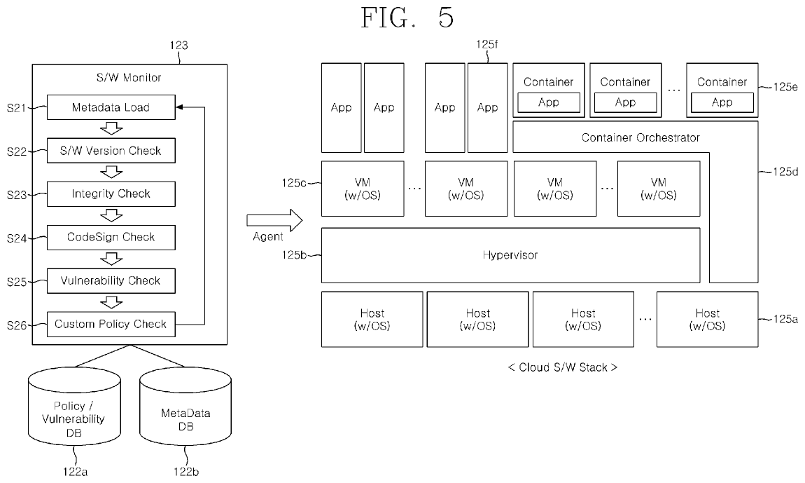

In addition, FIG. 4 is a flow chart illustrating a method for managing a software component according to another embodiment of the present disclosure, and FIG. 5 specifically illustrates a method for managing a software component according to another embodiment of the present disclosure.

In addition, as shown in FIG. 4, a method for managing a software component according to an embodiment of the present disclosure may include, in a method for managing multiple types of software components: receiving, by a software monitor 123, meta information relating to installation of one or more software components among the multiple types of software components (operation S210); and verifying the one or more software components on the basis of the meta information (operation S220), and in this case, the meta information corresponds to information on details about provision, by a proxy server 121, of each piece of software installation data for installation of the multiple types of software components.

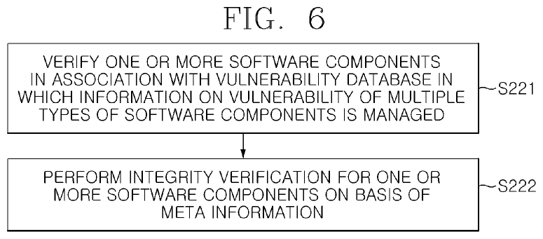

Here, the verifying (operation S220) may include, as shown in FIG. 6: verifying the one or more software components in association with a vulnerability database 122a in which information on vulnerability of the multiple types of software components is managed (operation S221); and performing integrity verification for the one or more software components on the basis of the meta information (operation S222).

In addition, the verifying (operation S220) may include verifying, by a software monitor 123, the one or more software components in connection with an agent of each of the one or more software components.

In addition, the verifying (operation S220) may include storing, as the meta information, a result of the verification of the one or more software components.

Accordingly, in a method, an apparatus, a system, and a computer system for managing a software component according to an embodiment of the present disclosure, a concentrated and consistent environment for management of several software components constituting a cloud environment, etc. can be provided, and moreover, visibility enabling easy and clear identification of information on installation, upgrade, etc. of software components constituting a cloud environment can be provided.

Hereinafter, the method for managing a software component according to another embodiment of the present disclosure is described in more detail with reference to FIGS. 4 and 5.

First, in operation S210, the software monitor 123 may receive meta information of installation of one or more software components among the multiple types of software components.

In a more specific example, as shown in FIG. 5, the software monitor 123 may receive meta information of installation of one or more software components among the multiple types of software components from the data base 122a and 122b in accordance with a pre-configured period, etc.

In this case, the software monitor 123 may be implemented as a separate server device, but the present disclosure is not limited thereto, and in addition to the server device, may be implemented in various forms such as a case where the software monitor is implemented as software, etc. operating on a server device.

In operation S220, the software monitor 123 performs verification of the one or more software components on the basis of the meta information.

In a more specific example, as shown in FIG. 5, the software monitor 123 may load S21 meta information from the database 122b, etc., and then may perform verification of one or more of software version verification S22 for the software installation data on the basis of the meta information, integrity verification S23, certificate verification S24, vulnerability verification S25, and verification S26 according to a policy configured in each cloud system 120.

In addition, in operation S220, vulnerability verification of the one or more software components is performed in association with a vulnerability database 122a in which information on vulnerability of the multiple types of software components is managed; and moreover, sequentially performing verification including integrity verification for the one or more software components on the basis of the meta information.

In addition, in operation S220, the software monitor 123 may perform verification of the one or more software components in connection with an agent of each of the one or more software components.

Moreover, in operation S220, a result of the verification of the one or more software components may be stored in the database 122b, etc., as meta information, so as to be managed to be used later.

Accordingly, the method for managing a software component according to an embodiment of the present disclosure, various meta information for the multiple types of software components constituting a cloud environment, etc. can be collected and managed, and the meta information can be reflected to the management of the software component and can be provided to a manager.

In addition, with respect to the method for managing a software component according to an embodiment of the present disclosure, a more specific example of an operation in the perspective of installation or updating is described.

First, in the present disclosure, a policy for a software component constituting a cloud environment may be established, and may be connected with a monitoring function of the software monitor 123.

In relation to this, in the present disclosure, the vulnerability database 122a for the software component may be connected with the software monitor 123.

In a more specific example, as shown in FIG. 5, the software monitor 123 may periodically load a list (for example, details of software components for which transmission is allowed for installation for a cloud environment) of meta information stored in the database 122b, etc. by the proxy server 121.

Accordingly, the software monitor 123 may verify specific details of the meta information by using the loaded list of meta information.

In addition, the software monitor 123 may perform, in connection with an agent, verification (for example, a software version, a code signature, integrity, vulnerability, a user-defined policy, a disallowed process, etc.) of an installation and operation status of a software component operating in an actual cloud environment.

Moreover, the software monitor 123 may sequentially perform the following processes.
(1) Identify an influence on newly occurring vulnerability (for example, vulnerability of a newly distributed opensource) on the basis of the contents of meta information loaded from a database 122b
(2) Thereafter, perform verification (for example, code integrity, etc.) a status of a software component distributed in an actual cloud environment with reference to the contents of meta information loaded from the database 122b

Moreover, in the present disclosure, the software monitor 123 may store, in the database 122b, a checking result (for example, success/failure) in the management perspective above, or may transmit the contents of a problem according to the checking result to a terminal or provide the same via e-mail, etc., so as to notify a manage of the same.

In addition, a computer-readable storage medium according to another aspect of the present disclosure is a computer-readable storage medium storing instructions configured to, when executed by a processor, cause an apparatus including the processor to implement operations for managing multiple types of software components, and the operations may include: receiving a request for installation of one or more software components among the multiple types of software components, and transferring the same to each corresponding software provision unit; receiving, from the software provision unit, each of one or more pieces of software installation data for installation of the one or more software components; and determining whether to provide the one or more pieces of software installation data, so as to perform installation of the one or more software components, through verification of the one or more pieces of software installation data.

In addition, a computer-readable storage medium according to another aspect of the present disclosure is a computer-readable storage medium storing instructions configured to, when executed by a processor, cause an apparatus including the processor to implement operations for managing multiple types of software components, and the operations may include: receiving meta information relating to installation of one or more software components among the multiple types of software components; and verifying the one or more software components on the basis of the meta information, wherein the meta information corresponds to information on details about provision, by a proxy server, of each piece of software installation data for installation of the multiple types of software components.

In this case, a computer program stored in the storage medium may be a computer program stored in a computer-readable storage medium to execute, in a computer, each operation of the above-described method for managing a software component. Here, the computer program may be not only a computer program including a machine language code generated by a compiler but also a computer program including a high-level language code which can be executed in a computer by using an interpreter, etc. In this case, the computer is not limited to a personal computer, a lap top computer, or the like, and includes all information processing devices such as a server, a smartphone, a table PC, a PDA, and a mobile phone, the information processing devices including a central processing unit (CPU) and capable of executing a computer program.

In addition, a computer-readable storage medium may continue to store a program executable by a computer, or may temporarily store the program for execution or download. In addition, the medium may be various recording means or storage means of a form in which one or multiple pieces of hardware are combined, and is not limited to a medium directly connected to a computer system, but may be one distributed over a network. Therefore, the above detailed description is to be construed in all aspects as illustrative and not restrictive. The scope of the present disclosure should be determined by reasonable interpretation of the appended claims, and all modifications within the equivalency range of the present disclosure are included in the scope of the present disclosure.

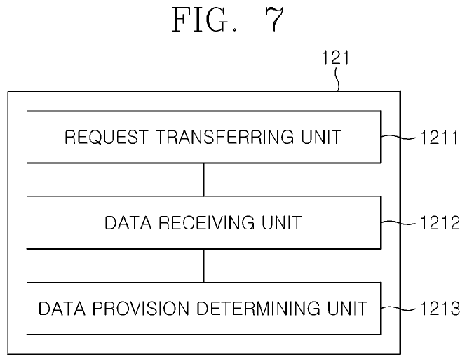

In addition, FIG. 7 is a diagram illustrating a configuration of a proxy server 121 according to an embodiment of the present disclosure.

As shown in FIG. 7, a proxy server 121 according to an embodiment of the present disclosure may include a request transferring unit 1211, a data receiving unit 1212, and a data provision determining unit 1213.

In addition, according to an embodiment, the proxy server 121 may be implemented to include a computing device in FIG. 8 and a description below in relation to FIG. 8. For example, the processor 10 may perform an instruction configured to implement operations for correcting table coordinate information, and the operations may include an operation of each of the request transferring unit 1211, the data receiving unit 1212, and the data provision determining unit 1213.

Hereinafter, each element of the proxy server 121 according to an embodiment of the present disclosure is described. In this case, more detailed contents of the proxy server 121 according to an embodiment of the present disclosure may be inferred from the description above relating to the method for managing a software component according to an embodiment of the present disclosure, and a more detailed description is omitted below.

First, the request transferring unit 1211 receives a request for installation for one or more software components among the multiple types of software components, and transfers the same to each corresponding software provision unit.

In addition, the data receiving unit 1212 receives, from the software providing unit, each of one or more pieces of software installation data for installation of the one or more software components.

Lastly, the data provision determining unit 1213 determines whether to provide the one or more pieces of software installation data, so as to perform installation of the one or more software components, through verification of the one or more pieces of software installation data.

Here, the data provision determining unit 1213 may apply a predetermined policy to determine whether to provide the one or more pieces of software installation data through verification of the one or more pieces of software installation data.

In addition, the data provision determining unit 1213 may store, in a database 122b, a result of the verification of the one or more pieces of software installation data.

In addition, the data provision determining unit 1213 may store, in the database 122b, meta information relating to details about provision of the one or more pieces of software installation data.

In this case, the meta information may include one or more of identification information of the software component, version information, type information, information on a transmission time point, and information on an item of verification performed for the software installation data.

In addition, the proxy server 121 may further include an information provision unit (not shown) for transmitting a part or all of the meta information stored in the database 122b to a terminal so as to provide the same to a manager.

In addition, FIG. 8 illustrates a device 200 to which a method proposed in the present disclosure is applicable.

Referring to FIG. 8, the device 200 may be configured to implement a management process for a software component according to a method proposed in the present disclosure. For example, the device 200 may be a proxy server 121 or a software monitor 123 for managing a software component constituting a cloud environment.

For example, the device 200 to which the method proposed in the present disclosure is applicable may include a network device such as a repeater, a hub, a bridge, a switch, a router, and gateway, a computing device such as a desktop computer and a work station, a mobile terminal such as a smartphone, a portable device such as a lap top computer, home appliances such as a digital TV, a transportation means such as a vehicle. In another example, the device 200 to which the present disclosure is applicable may be included as a part of an application specific integrated circuit (ASIC) implemented in the form of a system on chip (SoC).

A memory 20 may be operatively connected to a processor 10, may store a program and/or instructions for processing and control of the processor 10, and may store data and information sued in the present disclosure, control information required for data and information processing according to the present disclosure, temporary data generated in the process of data and information processing, etc. The memory 20 may be implemented as a storage device such as a read-only memory (ROM), a random-access memory (RAM), an erasable programmable read-only memory (EPROM), an electrically erasable programmable read-only memory (EEPROM), a flash memory, a static RAM (SRAM), a hard disk drive (HDD), and a solid-state drive (SSD).

The processor 10 may be operatively connected to the memory 20 and/or a network interface 30, and controls an operation of each module in the device 200. Specifically, the processor 10 may perform various control functions for performing the method proposed in the present disclosure. The processor 120 may be called a controller, a microcontroller, a microprocessor, a microcomputer, etc. The method proposed in the present disclosure may be implemented by hardware or firmware, software, or a combination thereof. When the present disclosure is implemented using hardware, the processor 10 may include an application specific integrated circuit (ASIC), a digital signal processor (DSP), a digital signal processing device (DSPD), a programmable logic device (PLD), a field programmable gate array (FPGA), or the like, configured to perform the present disclosure. When the method proposed in the present disclosure is implemented using firmware or software, the firmware or the software may include instructions related to a module, a procedure, a function, or the like performing a function or operations required to implement the method proposed in the present disclosure, and the instructions may be configured to be stored in the memory 210, or stored in a computer-readable recording medium (not shown) separate from the memory 20, so as to cause, when executed by the processor 10, the device 120 to implement the method proposed in the present disclosure.

In addition, the device 200 may include a network interface device 30. The network interface device 30 may be operatively connected to the processor 10, and the processor 10 may control the network interface device 30 to transmit or receive a wired/wireless signal carrying information and/or data, a signal, a message, etc. through a wireless/wired network. For example, the network interface device 30 may support various communication specifications such as IEEE 802 system, 3GPP LTE(-A), and 3GPP 5G, and may transmit or receive a control information and/or data signal according to a corresponding communication specification. The network interface device 30 may be implemented outside the device 200 as necessary.

Accordingly, in a method, an apparatus, a system, and a computer system for managing a software component according to an embodiment of the present disclosure, a concentrated and consistent environment for management of several software components constituting a cloud environment, etc. can be provided.

In addition, in a method, an apparatus, a system, and a computer system for managing a software component according to an embodiment of the present disclosure, visibility enabling easy and clear identification of information on installation, upgrade, etc. of software components constituting a cloud environment can be provided.

More specifically, conventionally, an update file, or the like is differently distributed to each distribution server for each software component, but in a method, an apparatus, a system, and a computer system for managing a software component according to an embodiment of the present disclosure, integrated management and installation can be performed for several software components through a network proxy, and moreover, information on upgrade, etc. of several software components can be integrally identified through the network proxy, and thus can be efficiently managed.

The embodiments and drawings described and shown and herein are illustrative examples, and are not intended to otherwise limit the scope of the present disclosure in any way. Furthermore, the connecting lines or connectors between elements shown in the drawings are intended to illustratively represent functional connections and/or physical or logical connections, and various alternative or additional functional connections, physical connections, or circuitry connections may be present in an actual device. In addition, no element is essential to the application of of the present disclosure unless the element is specifically described as “essential”, “critical”, or the like.

The term “the” and indicative terms similar thereto used herein (particularly, claims) may be used for both singular expressions and plural expressions. In addition, in a case in which a range is disclosed in the present disclosure, individual values falling into the range are applied to the present disclosure (unless disclosed to the contrary), and the range is identical to the individual values described in the detailed description of the disclosure. In addition, the operations, presented in the disclosure of the method in the present invention, are not intended to necessarily limit the order of the sequence, the order may be appropriately changed as necessary as long as any one operation does not need to be performed necessarily prior to the other operations because of the nature of each process. All examples or illustrative terms (“for example” or “etc.”) used in the present disclosure are merely used to explain the present disclosure in detail, and the scope of the present disclosure is not limited by the examples or the illustrative terms as long as the examples or the illustrative terms are not disclosed in the claims. In addition, it can be understood by those skilled in the art that the present disclosure may be configured according to the claims to which various modifications, combinations, and alterations are added, or on the basis of design conditions and elements within the scope equivalent to the scope of the claims.

What is claimed is:

1. A method for managing multiple types of software components, the method being performed by one or more processors in a proxy server, and comprising:
receiving a request for installation of one or more software components among the multiple types of software components, and transferring the received request to each corresponding software provision unit;
receiving, from the software provision unit, each of one or more pieces of software installation data for installation of the one or more software components; and
determining whether to provide the one or more pieces of software installation data, so as to perform installation of the one or more software components, through verification of the one or more pieces of software installation data.

2. The method of claim 1, wherein the determining comprises applying, by the proxy server, a predetermined policy, and determining whether to provide the one or more pieces of software installation data, through verification of the one or more pieces of software installation data.

3. The method of claim 1, wherein the determining comprises storing, by the proxy server, a result of the verification of the one or more pieces of software installation data in a database.

4. The method of claim 1, wherein the determining comprises storing, by the proxy server, meta information relating to details about provision of the one or more pieces of software installation data in a database.

5. The method of claim 4, wherein in the determining, the meta information comprises one or more of identification information of the software component, version information, type information, information on a transmission time point, and information on an item of verification performed for the software installation data.

6. The method of claim 4, further comprising transmitting a part or all of the meta information stored in the database to a terminal so as to provide the same to a manager.

7. A method for managing multiple types of software components, the method being performed by one or more processors in a software monitor, and comprising:
receiving meta information relating to installation of one or more software components among the multiple types of software components; and
verifying the one or more software components on the basis of the meta information,
wherein the meta information corresponds to information on details about provision, by a proxy server, of each piece of software installation data for installation of the multiple types of software components.

8. The method of claim 7, wherein the verifying comprises:
verifying the one or more software components in association with a vulnerability database in which information on vulnerability of the multiple types of software components is managed; and
performing integrity verification for the one or more software components on the basis of the meta information.

9. The method of claim 7, wherein the verifying comprises verifying, by the software monitor, the one or more software components in connection with an agent of each of the one or more software components.

10. The method of claim 7, wherein the verifying comprising storing, as the meta information, a result of the verification of the one or more software components.

11. A computer-readable storage medium storing instructions configured to, when executed by a processor, cause an apparatus comprising the processor to implement operations of managing multiple types of software components, the operations comprising:
receiving a request for installation of one or more software components among the multiple types of software components, and transferring the received request to each corresponding software provision unit;
receiving, from the software provision unit, each of one or more pieces of software installation data for installation of the one or more software components; and
determining whether to provide the one or more pieces of software installation data, so as to perform installation of the one or more software components, through verification of the one or more pieces of software installation data.

12. A computer-readable storage medium storing instructions configured to, when executed by a processor, cause an apparatus comprising the processor to implement operations of managing multiple types of software components, the operations comprising:
receiving meta information relating to installation of one or more software components among the multiple types of software components; and
verifying the one or more software components on the basis of the meta information,
wherein the meta information corresponds to information on details about provision, by a proxy server, of each piece of software installation data for installation of the multiple types of software components.

13. A proxy server comprising a processor and configured to manage multiple types of software components,
wherein the processor is configured to:
receive a request for installation of one or more software components among the multiple types of software components, and transfer the received request to each corresponding software provision unit;
receive, from the software provision unit, each of one or more pieces of software installation data for installation of the one or more software components; and
determine whether to provide the one or more pieces of software installation data, so as to perform installation of the one or more software components, through verification of the one or more pieces of software installation data.

14. The proxy server of claim 13, wherein the determining whether to provide the data comprises applying a predetermined policy to determine whether to provide the one or more pieces of software installation data, through verification of the one or more pieces of software installation data.

15. The proxy server of claim 13, wherein the determining whether to provide the data comprises storing, in a database, a result of the verification of the one or more pieces of software installation data.

16. The proxy server of claim 13, wherein the determining whether to provide the data comprises storing, in a database, meta information relating to details about provision of the one or more pieces of software installation data.

17. The proxy server of claim 16, wherein the meta information comprises one or more of identification information of the software component, version information, type information, information on a transmission time point, and information on an item of verification performed for the software installation data.

18. The proxy server of claim 16, further comprising an information provision unit configured to transmit a part or all of the meta information stored in the database to a terminal so as to provide the same to a manager.

19. A software monitor comprising a processor and configured to manage multiple types of software components,
wherein the processor is configured to:
receive meta information relating to installation of one or more software components among the multiple types of software components; and
verify the one or more software components on the basis of the meta information,
wherein the meta information corresponds to information on details about provision, by a proxy server, of each piece of software installation data for installation of the multiple types of software components.

20. The software monitor of claim 19, wherein the verifying comprises:
verifying the one or more software components in association with a vulnerability database in which information on vulnerability of the multiple types of software components is managed; and
performing integrity verification for the one or more software components on the basis of the meta information.
